(19) United States
(12) Patent Application Publication
(10) Pub. No.: US 2009/0285430 A1
(43) Pub. Date: Nov. 19, 2009

(54) Article with sound emitter

(76) Inventor: Steven Rifkind, West Windsor, NJ (US)

Correspondence Address: DICKSTEIN SHAPIRO LLP, 1633 Broadway, NEW YORK, NY, 10019, US

(21) Appl. No.: 12/152,809

(22) Filed: May 15, 2008

(51) Int. Cl. H04R 1/02

(52) U.S. Cl. 381/333

(57) ABSTRACT

A washable and dryable article sound emitting device incorporated into an article, such as a backpack, towel, blanket, bib, garment, and slippers. The sound emitting device includes a waterproof casing configured to withstand the tumbling and high temperatures associated with a standard clothing dryer.

### FIELD OF THE INVENTION

The present invention generally relates to a machine washable and dryable sound emitting device and articles incorporating same.

### BACKGROUND INFORMATION

The miniaturization of consumer electronics has made such devices nearly ubiquitous. There is a need to functionally pair electronic devices to everyday articles such as garments, towels, shoes, bags, etc., while maintaining the machine washability and dryability of these articles.

### SUMMARY

An exemplary embodiment of the present invention is an article with a sound emitting device functionally connected, e.g., either permanently affixed or removably connected, thereto. Non-limiting examples of the article include garments, bibs, slippers, tote bags, towels, pillows, blankets and other bedding.

The sound emitting device includes a sound emitter, e.g., a speaker or transducer, configured to generate a sound generally associated with the article upon the triggering of a switch, e.g., a pushbutton, by a user. For example, if the article is a shirt with a cartoon character on it, the sound emitter may reproduce a clip of the character talking or singing. If the article is a tote bag in the shape of a car or decorated with pictures or illustrations of cars, the sound emitter may, for example, reproduce the sound of a running engine or a car driving by at a high speed, etc.

The sound emitting device is designed to withstand numerous, i.e., at least five or more, wash and dry cycles in a machine washer and dryer. Pursuant to FTC labeling standards, in particular 16 CFR Part 423, Appendix A, the term “machine wash” means “a process by which soil may be removed from products or specimens through the use of water, detergent or soap, agitation, and a machine designed for this purpose.” Cold water is defined as water temperatures up to 86 degrees Fahrenheit (30 degrees Celsius) and hot water temperature as water temperatures ranging from 112 to 145 degrees Fahrenheit (45 to 63 degrees Celsius). The mechanism of a clothes dryer is that of a rotating tumbler and an electric or gas powered heater used to heat air, drawn through the articles being dried as they tumble, to a temperature above the vaporization point of water, i.e., 212 degrees Fahrenheit (100 degrees Celsius).

A waterproof casing, surrounding the sound emitting device, is adapted to remain sealed and withstand the tumbling and high heat associated with a standard gas or electric clothing dryer. The waterproof casing is also configured to absorb the impact forces generated during the wash and dry cycles and to physically shield the sound emitter and switch from water and heat generated during the wash and dry cycles of a washing machine and dryer.

In an exemplary embodiment, the casing is made from polyvinyl chloride (PVC), e.g., as a film or mask approximately 0.70 mm thick. In the process of polymerization the monomer 1-chloroethene is polymerized through its carbon-carbon double bond into the polymer PVC. Certain chemicals may be incorporated into the polymer composition as plasticizers, e.g., to provide flexibility to the material and certain other chemicals may be added as stabilizers, e.g., to extend the life of the PVC against the effects of heat, water, physical stress and oxidative degradation. In an exemplary embodiment, the PVC composition used to produce the waterproof casing provides for the right balance between shock absorption and stiffness to maintain the life of the sound emitting device encapsulated therein through numerous wash and dry cycles while still being soft enough to allow a user to depress a button connected to the sound emitting device so as to trigger the sound emitting device.

Non-limiting examples of plasticizers include, but are not limited to, stearyl citrate or tributyl citrate, as well as certain dialkyl adipate esters and dialkyl azelate esters. Non-limiting examples of stabilizers include, but are not limited to, the phenols and their derivatives, amines and their derivatives, hydroxyazines, oximes, polymeric phenolic esters and the salts of multivalent metals in which the metal is in its lowest valence state, such as butyltin carboxylate/mercaptide. In an exemplary embodiment, the PVC compound will contain a range by weight of approximately 55% to 60% polyvinyl chloride resin, 35% to 40% plasticizers, and 2% to 5% stabilizers.

In an exemplary embodiment, the sound emitting device is sized and configured to minimize the frequency and severity of impact with the drum or other components inside a standard gas or electric clothing dryer.

In an exemplary embodiment, the waterproof casing may have a round or oval shape. The shape may be configured and adapted to the nature of the article to which the device is attached or affixed. Further, the shape may be configured so as to minimize the frequency and severity of impact with the drum or other components inside a standard gas or electric clothing dryer.

In an exemplary embodiment, the article is a shoe, garment, or tote bag and the speaker is oriented to face an inside of the shoe, garment, or tote bag.

According to an exemplary method of the present invention, a sound emitting device is sealed inside a waterproof casing, the waterproof casing is connected to an article, the article is washed in a standard clothing washer and then dried using a standard gas or electric clothing dryer in no way affecting the operability of the sound emitting device, and then the switch on the sound emitting device is triggered, which generates a sound, e.g., a playback of a prerecorded sound on the sound emitting device.

A sound emitting device according to an exemplary embodiment of the present invention comprises a sound emitter, a switch, and a waterproof casing. Triggering of the switch causes the sound emitter to generate a sound. The waterproof casing completely surrounds the sound emitter and switch. The sound emitting device is adapted to withstand numerous washing and drying cycles in a machine washer and a machine dryer. The waterproof casing is configured to protect the sound emitter and switch during the cycles by, at least one of sufficiently absorbing impact forces generated during the cycles and physically shielding the sound emitter and switch from water and heat generated during the cycles.

In an exemplary embodiment, the sound emitting device further includes a support, e.g., a rigid support, disposed between the sound emitter and switch. The support supports a control unit in communication with both the sound emitter and switch and is configured to control the sound emitter. The sound emitter is mounted on a first side of the support and faces away from the switch and control unit both of which are mounted on a second side of the support opposite the first side.

In an exemplary embodiment, the sound emitting device further includes a cover enclosed within the waterproof casing and completely surrounding the sound emitter but not the switch or the control unit.

In an exemplary embodiment, the waterproof casing has a flange. The flange may have a radial width of at least 3 mm.

In an exemplary embodiment, the sound emitting device may weigh less than approximately 14 grams.

In an exemplary embodiment, the switch includes a pushbutton trigger.

In an exemplary embodiment, a portion of the casing is flexible enough so as to allow the switch to be triggered through the casing.

In an exemplary embodiment, the waterproof casing includes a casing body and a cover fused to the casing body via a single continuous high frequency heat seal weld.

In an exemplary embodiment, the casing body is cylindrical, closed on one end, and has a flange on an opposite end. Further, the cover is round and connected to the flange. A diameter of the flange and a diameter of the cover are both approximately 7% larger than a diameter of the cylindrical casing body.

In an exemplary embodiment, the sound generated by the sound emitting device is loud enough to be heard outside the casing and at a volume of at least 40 decibels.

In an exemplary embodiment, the support is a printed circuit board secured in a recess in the cover.

An article according to an exemplary embodiment of the present invention comprises a body and a sound emitting device connected to the body. The article may comprise, for example, a garment, shoe, backpack, bag, towel, bib, and bedding. The sound emitting device includes a sound emitter, a switch, and a waterproof casing. Triggering of the switch causes the sound emitter to generate a sound generally related to or associated with the article. The waterproof casing completely surrounds the sound emitter and switch. The sound emitting device is adapted to withstand numerous washing and drying cycles of the article in a machine washer and a machine dryer. The waterproof casing is configured to protect the sound emitter and switch during the cycles by at least one of sufficiently absorbing impact forces generated during the cycles and physically shielding the sound emitter and switch from water and heat generated during the cycles.

In an exemplary embodiment, the sound emitter faces a chamber defined by the body and the switch faces away from the chamber.

In an exemplary embodiment, the article is configured to be worn by a user such that the sound emitter faces or contacts the user during use and the switch projects in an opposite direction away from the user.

In an exemplary embodiment, the sound emitting device is configured such that triggering the switch a first time generates the sound, and triggering the switch a second time generates a different sound also related to or associated with the article.

In an exemplary embodiment, the sound emitting device may further include a pushbutton used to trigger the switch. The sound emitting device may be configured such that depression of the pushbutton for a predetermined period of time turns the sound emitting device off, in which state depression of the pushbutton does not generate a sound. The sound emitting device may also be configured such that depression of the pushbutton for a predetermined period of time turns the sound emitting device on.

Reference throughout this specification to “an embodiment” or “one embodiment” or “an exemplary embodiment” means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

An example embodiment of the present invention is described in more detail below with reference to the appended Figures. The foregoing description and examples have been set forth as mere illustrations and are not intended to be limiting. Each of the disclosed aspects and embodiments may be considered individually or in combination with other aspects, embodiments, and variations thereof. The steps of the methods described herein are not confined to any particular order of performance.

### BRIEF DESCRIPTION OF THE DRAWINGS

FIG. 1A is a perspective view of a backpack according to an exemplary embodiment of the present invention.

FIG. 1B is a plan view of a towel according to an exemplary embodiment of the present invention.

FIG. 1C is a plan view of a blanket according to an exemplary embodiment of the present invention.

FIG. 1D is a plan view of a bib according to an exemplary embodiment of the present invention.

FIG. 1E is a perspective view of a garment according to an exemplary embodiment of the present invention.

FIG. 1F is a perspective view of slippers according to an exemplary embodiment of the present invention.

FIG. 2A is a top view of an exemplary embodiment of the sound emitter device of the present invention.

FIG. 2B is a cross sectional view of the sound emitter device of FIG. 2A taken along lines 2B-2B.

FIG. 3 is a circuit diagram for the sound emitter device according to an exemplary embodiment of the present invention.

FIG. 4A is a schematic diagram of an exemplary waterproof casing in disassembled form.

FIG. 4B is a schematic diagram of an exemplary waterproof casing in disassembled form.

FIG. 4C is a schematic diagram of an exemplary waterproof casing in disassembled form.

### DETAILED DESCRIPTION

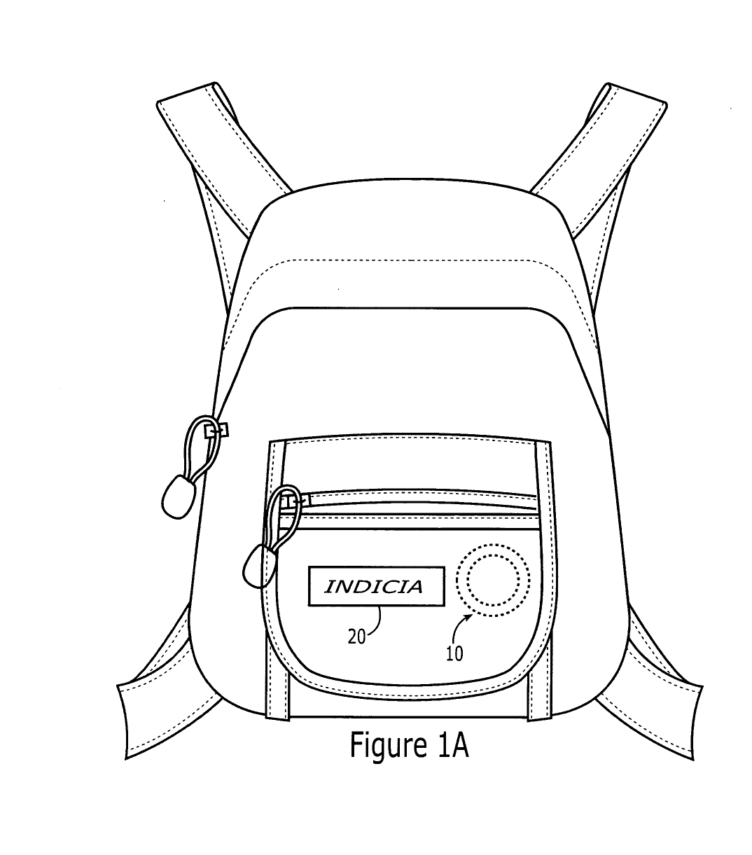

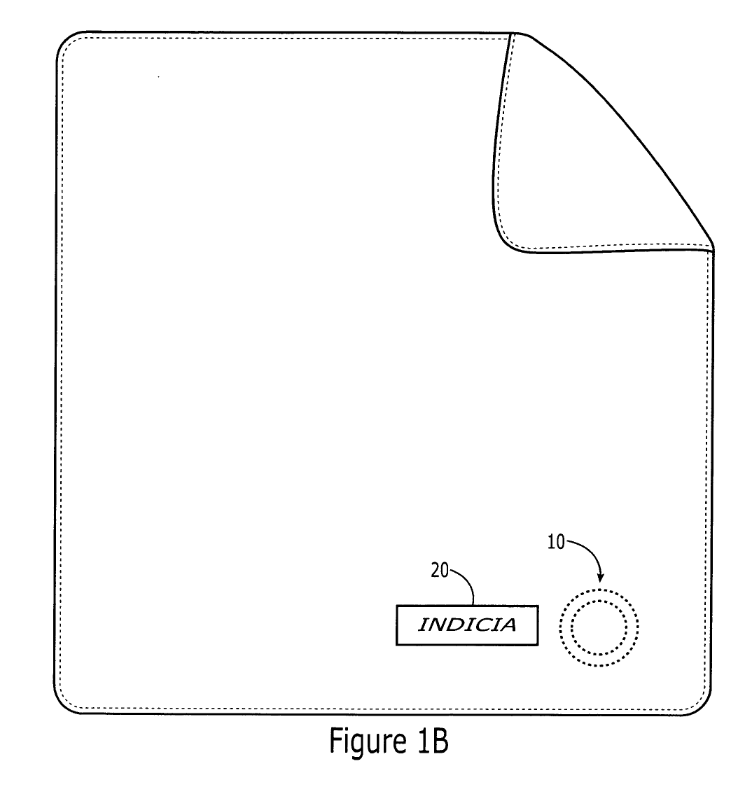

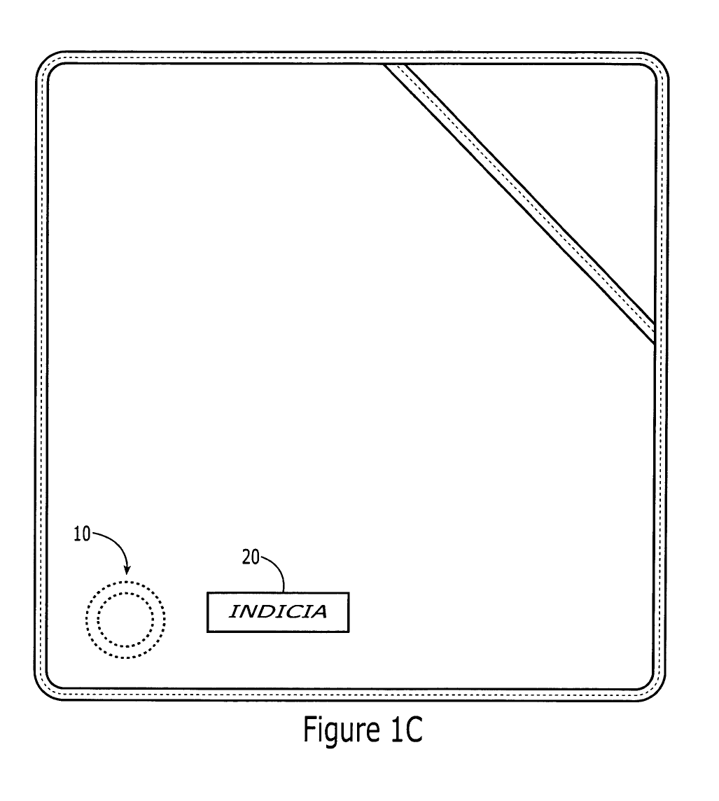

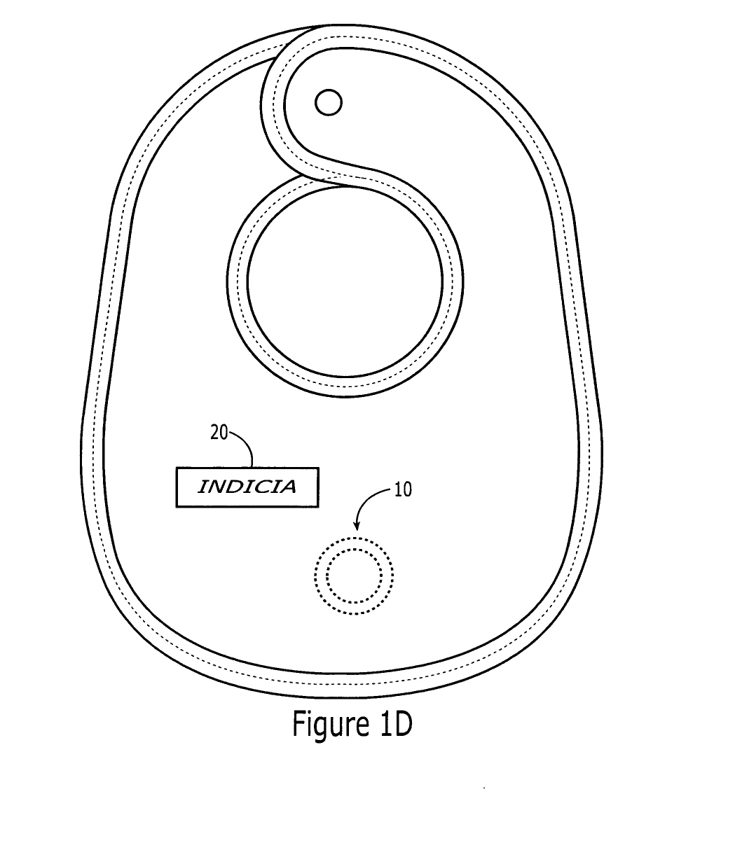

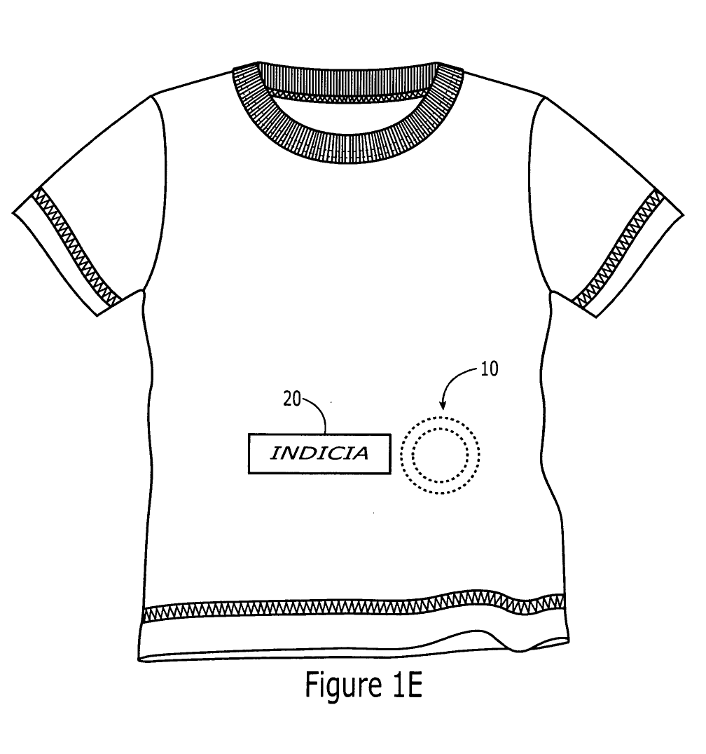

Various articles according to an exemplary embodiment of the present invention, including a backpack, towel, blanket, bib, garment, and slippers, are illustrated schematically in FIGS. 1A-1F, respectively. All of the articles incorporate a sound emitting device 10, which is connected to the article, and optional indicia 20. The sound emitting device 10 may be clipped or adhered to the article or embedded or stitched between two layers of material making up the article. Alternatively, a patch may be sewn or adhered over the sound emitting device 10 onto the article sandwiching it between the patch and the article. The illustrated articles are merely exemplary and can include any article capable of incorporating the sound emitter.

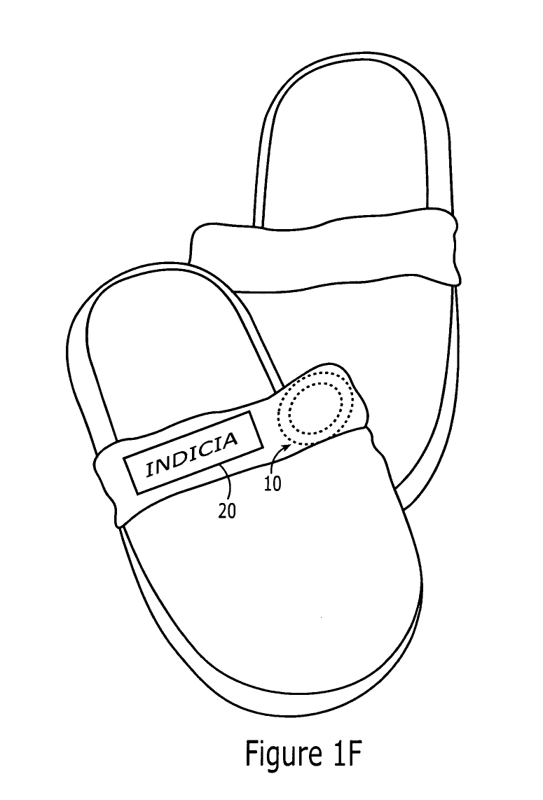

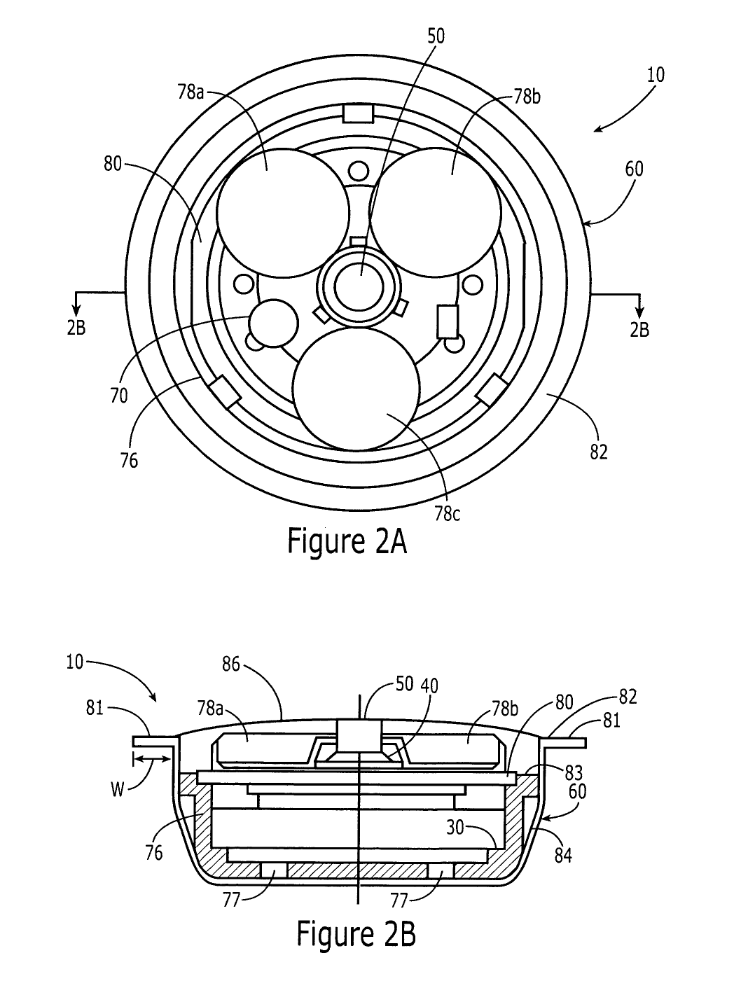

FIG. 2A is a top view of the sound emitting device 10 encased in a waterproof case 60. FIG. 2B is a cross sectional view of the sound emitting device 10 and case 60 taken along lines 2B-2B in FIG. 2A. FIG. 3 is a circuit diagram for the sound emitter device 10.

The sound emitting device 10 includes a sound emitter 30, e.g., a speaker or a vibrating piezoelectric transducer, configured to generate a sound upon the triggering of a switch 40, e.g., via a depression and release of pushbutton 50. The sound may optionally be generally related to or associated by a user with the article or indicia 20 on the article. For example, if the article is a shirt with a cartoon character, the sound emitter 30 may reproduce a clip of the character talking or singing. If the article is a bag or backpack in the shape of a car or decorated with illustrations or pictures of cars, the sound emitter 30 may, for example, reproduce the sound of a running engine or a car driving by at a high speed, etc.

The sound emitter 30 may, for example, be a cone speaker incorporating a frame, voice coil and driver magnet, which has a height of 5 mm and diameter of 27 mm.

In an exemplary embodiment, the sound emitter 10 may be able to generate multiple different sounds and may include multiple pushbuttons used to trigger these sounds. Alternatively, the sound emitter device 10 may be designed such that depressing pushbutton 50 multiple times, e.g., twice in quick succession, produces a different sound than just pressing the pushbutton 50 once. Further yet, the sound emitter device 10 may be designed such that each depression and release of the pushbutton 50 generates a different sound from a playlist stored in the sound emitter device 10 until the list is exhausted and the list repeats. In such exemplary embodiment, if two sounds are stored in the sound emitter device 10, the first depression and release of the pushbutton 50 would generate the first sound, the second depression and release of the pushbutton 50 would generate the second sound, and the third depression and release of the pushbutton would cause the device to loop back and generate the first sound again, etc.

The sound emitting device 10 may also be designed with a separate on/off switch (not shown). This may be useful, for example, when the sound emitting device 10 is incorporated in a child's garment allowing the parent to turn off the sound emitter 10 to prevent inadvertent activation while the child wearing the garment is sleeping. In an exemplary embodiment, pushbutton 50 may also be used as an on/off switch. For example, the sound emitting device 10 may be designed such that depression and holding of the pushbutton 50 down for a predetermined amount of time, e.g., 3 seconds, turns the sound emitter on or off.

Sound emitter 30 and switch 40 communicate with a control unit 70, which is mounted on a printed circuit board (PCB) 80 and powered by a power source 78a, 78b, 78c. Switch 40 is connected between the power source 78a, 78b, 78c and the control unit 70. A resistor 31 is connected between the power source 78a, 78b, 78c and the control unit 70. Sound emitter 30 is enclosed within a cover 76.

Depression of pushbutton 50 closes switch 40 and changes the state of an input 72 to control unit 70, which is programmed and configured to output a sound signal 74 to sound emitter 30 upon detecting the change of state of input 72 triggered by depression of pushbutton 50. The sound signal 74 is sent to sound emitter 30, which translates it into sound waves reflective of sound information stored in a memory associated with the control unit 70 (which memory can be integrated with or separate from the control unit 70). As indicated above, the sound generated by sound emitter 30 may be related to and/or generally associated by the user with the design of the article or indicia on the article into which the sound emitting device 10 is integrated. The control unit 70 may, for example, be an AM9AD series integrated circuit chip manufactured by Alpha Electronics.

In an exemplary embodiment, control unit 70 may be programmed to generate different sound signals 74 dependent on a pattern in the change of state of input 72. For example, if the state of input 72 changes twice within a period of less than a second (consistent with pushbutton being depressed twice in quick succession) the control unit 70 can be programmed to output a different sound signal 74 signal so as to produce a second sound. In this manner, multiple different sounds stored in control unit 70 can be easily accessed by a user. Further, if input 72 changes state for a period over, e.g., 3 seconds, control unit 70 can be programmed to turn on or off.

As illustrated, the power source 78 includes batteries, e.g., three 1.5 volt button cell batteries having an electrode, e.g., of either alkaline manganese or silver oxide, but can include any type of power source including solar panels or coils for inductive powering from a device physically separate from the sound emitting device 10. The sound emitting device 10 is designed to be both machine washable and machine dryable. Multiple design aspects of the sound emitting device 10 interact in synergistic fashion so to provide for this valuable feature.

As indicated above, the components of the sound emitting device 10 are surrounded by waterproof casing 60, which allows sound emitting device to survive numerous, i.e., at least five, wash and dry cycles. The casing 60 is designed no only so as to shield the sound emitting device from water and heat but also so as to absorb impact of the sound emitting device against the machine washer and dryer drum (and other articles in the washer and dryer). At the same time, however, the casing 60 is made flexible enough to allow a user to depress the pushbutton 50 through the casing 60 without difficulty.

The casing 60 is made from polyvinyl chloride (PVC). In the process of polymerization the monomer 1-chloroethene is polymerized through its carbon-carbon double bond into the polymer PVC. Certain chemicals may be incorporated into the polymer composition as plasticizers, e.g., to provide flexibility to the material and certain other chemicals may be added as stabilizers, e.g., to extend the life of the PVC against the effects of heat, water, physical stress and oxidative degradation. In an exemplary embodiment, the PVC composition used to produce the casing provides for the right balance between shock absorption and stiffness to maintain the life of the sound emitting device encapsulated therein through numerous wash and dry cycles while still being soft enough to allow a user to depress a button connected to the sound emitting device so as to trigger the sound emitting device.

Non-limiting examples of plasticizers include, but are not limited to, stearyl citrate or tributyl citrate and certain dialkyl adipate esters and dialkyl azelate esters. Non-limiting examples of stabilizers include, but are not limited to, the phenols and their derivatives, amines and their derivatives, hydroxyazines, oximes, polymeric phenolic esters and the salts of multivalent metals in which the metal is in its lowest valence state, such as butyltin carboxylate/mercaptide. In an exemplary embodiment, the PVC compound will contain a range by weight of approximately 55% to 60% polyvinyl chloride resin, 35% to 40% plasticizers, and 2% to 5% stabilizers.

The casing thickness is approximately 0.70 mm and is relatively soft compared to the hard speaker case 76, which hard speaker case is made from a rigid plastic, e.g., unplasticized polyvinyl chloride (UPVC).

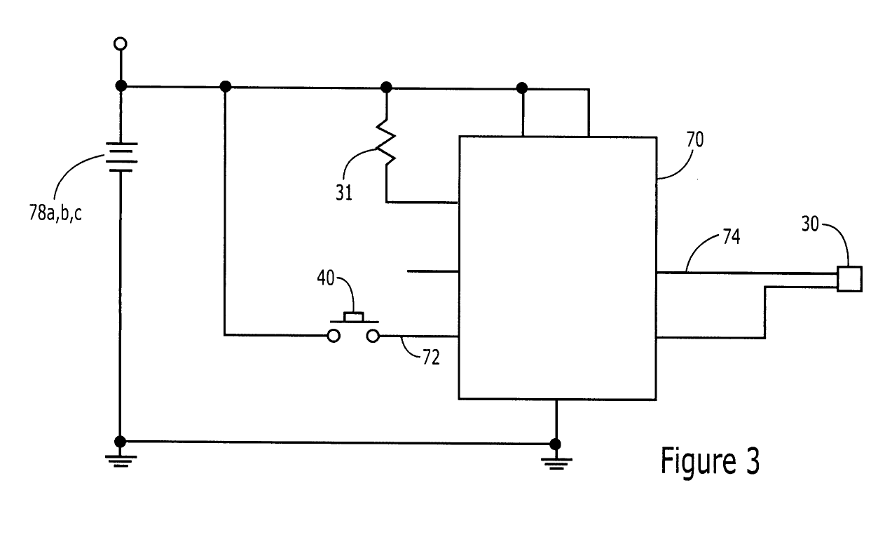

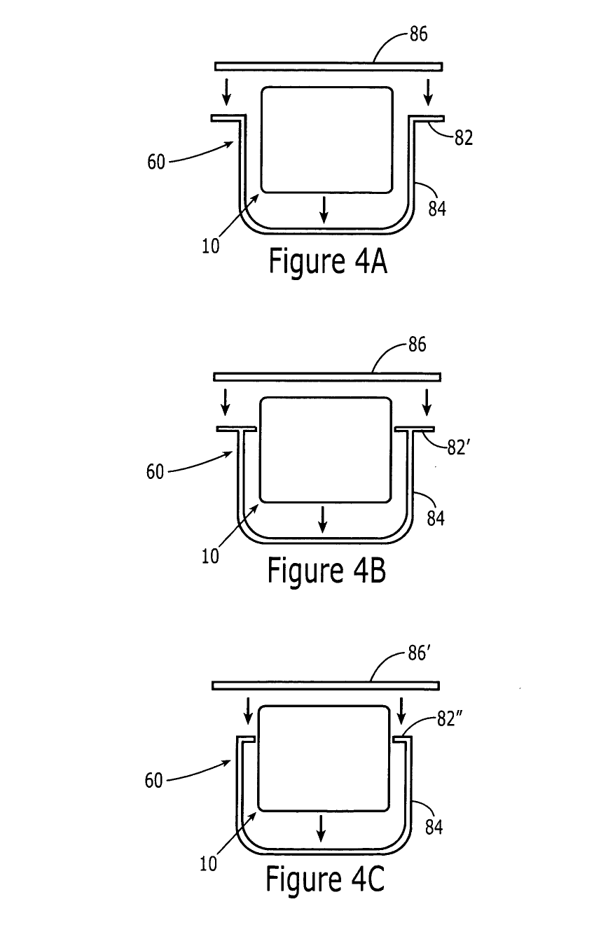

To reduce the likelihood the casing 60 will open, the casing 60 is sealed using a weld 81, e.g., a high frequency ultrasonic weld. As illustrated schematically in FIG. 4A, the sound emitting device 10 is placed inside a first cup-like portion 84 of the casing 60 with a flange 82 and a top portion 86 is placed over and welded to the flange 82, e.g., along an entire radial width of the flange 82. The use of a single weld and extension of the weld 81 over the entire radial width, W, of the flange 82 reduces the likelihood that the seal will open during wash and dry cycles exposing the sound emitting device 10 to damaging water and heat. The flange 82 flexes upon impact and thus absorbs some of the forces described above encountered by the sound emitting device 10 during washing and drying. The flange thickness is approximately 1.4 mm and its radial width is approximately 3 mm.

In an exemplary embodiment, as illustrated in FIG. 4B, the flange 82′ extends towards a center of the first cup-like portion 84. Alternatively, the flange 82″ may exclusively extend towards the center of the first cup-like portion 84, as illustrated in FIG. 4C. The diameter of cover 86″ in the embodiment of FIG. 4C matches that of the first-cup like portion 84.

In addition to the design of casing 60, another aspect of the sound emitter device design believed to contribute to its ability to survive numerous wash and dry cycles involves its size and configuration. In an embodiment including a speaker, the sound emitting device 10 is configured to be as light and small as possible, while still producing a clear and loud sound, e.g., at sound pressure levels of 60 to 70 decibels one meter from the device, including that of the human voice. In an exemplary embodiment, the weight of the overall device including the casing 60 is only 13.5 grams. Further, a cylindrical embodiment of the sound emitting device 10 measures 14 mm in height and 43 mm in diameter. It is believed that limiting the sound emitting device 10 size and weight reduces the frequency and severity of collision of the sound emitting device 10 with the dryer drum as the article is being dried in a machine dryer. This not only reduces the likelihood of damage to the sound emitting device via impact but also reduces the likelihood that casing 60 will open and its integrity comprised thereby exposing the sound emitting device 10 to water damage during washing and additional heat during drying.

One aspect of the design configuration of the sound emitter device 10 which allows for a reduction in size involves encasing only a portion of the device with a hard casing. As shown in FIG. 2B, cover 76 surrounds only sound emitter 30. The cover 76 snaps over the PCB 80 so as to secure the PCB 80 in a recess 83 in an inner surface of a sidewall of the cover 76. Cover 76 may include a plurality of holes 77 to minimize its muffling effect on the sound emitter 30.

Another aspect of the design configuration of the sound emitter device 10 which allows for a reduction in size involves the relative placement of the components. For example, placement of the sound emitter 30 on an opposite side of the PCB 80 to that of the switch 40 and control unit 70 allows the size of the device to be even further reduced. Even though this arrangement necessarily results in the sound emitter 30 facing either away from the ears of the user or into the article to which it is connected (given that the pushbutton 50 will generally be on the front or exposed surface of the article), the sound emitter 30 is designed to be sufficiently loud to assure that any muffling of the sound generated by the sound emitter 30 in this orientation is compensated for.

As illustrated in FIGS. 1A-1F, the sound emitting device 10 may be connected to a variety of articles. As shown, the casing 60 of the sound emitting device 10 (shown in broken lines) is sandwiched between two material layers of each article. The casing 60 may also, for example, be adhered or clipped to the article or fixed in place using a patch. The article may include indicia 20 directing the user where on the article to push so as to trigger the sound emitter device, e.g., language such as “Press Here!” As an alternative to the use of indicia or in combination with it, the pushbutton 50 may be exposed through a window in a front layer of the article.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications and variations will become apparent to the skilled practitioner upon a study of the drawings and specification. Such modifications and variations are considered to be within the purview and scope of the appended claims and their equivalents.

What is claimed is:

1. A sound emitting device comprising a sound emitter, a switch, and a waterproof casing, triggering of the switch causes the sound emitter to generate a sound, the waterproof casing completely surrounds the sound emitter and switch, the sound emitting device is adapted to withstand numerous washing and drying cycles in a machine washer and a machine dryer, the waterproof casing is configured to protect the sound emitter and switch during the cycles by at least one of sufficiently absorbing impact forces generated during the cycles and physically shielding the sound emitter and switch from water and heat to which the sound emitting device is exposed during the cycles.

2. The sound emitting device of claim 1, further comprising a support disposed between the sound emitter and switch, the support supporting a control unit in communication with both the sound emitter and switch and configured to control the sound emitter, the sound emitter mounted on a first side of the support and facing away from the switch and control unit both of which are mounted on a second side of the support opposite the first side.

3. The sound emitting device of claim 1, further comprising a cover enclosed within the waterproof casing and completely surrounding the sound emitter but not the switch or the control unit.

4. The sound emitting device of claim 1, wherein the waterproof casing has a flange.

5. The sound emitting device of claim 1, wherein the flange has a radial width of at least 3 mm.

6. The sound emitting device of claim 1, wherein the sound emitting device weighs less than approximately 14 grams.

7. The sound emitting device of claim 1, wherein the switch includes a pushbutton trigger.

8. The sound emitting device of claim 1, wherein at least a portion of the casing is flexible enough so as to allow the switch to be triggered through the casing.

9. The sound emitting device of claim 1, wherein the waterproof casing includes a casing body and a cover fused to the casing body via a single continuous high frequency heat seal weld.

10. The sound emitting device of claim 1, wherein the casing body is cylindrical, closed on one end, and has a flange on an opposite end, the cover is round and connected to the flange, a diameter of the flange and a diameter of the cover are both approximately 7% larger than a diameter of the cylindrical casing body.

11. The sound emitting device of claim 1, wherein the sound is loud enough to be heard outside the casing and at a volume of at least 40 decibels.

12. The sound emitting device of claim 1, wherein the sound emitter is a speaker.

13. The sound emitting device of claim 3, wherein the support is a printed circuit board secured in a recess in the cover.

14. An article, comprising a body, and a sound emitting device connected to the body, the sound emitting device comprising a sound emitter, a switch, and a waterproof casing, triggering of the switch causes the sound emitter to generate a sound generally related to or associated with the article, the waterproof casing completely surrounds the sound emitter and switch, the sound emitting device is adapted to withstand numerous washing and drying cycles of the article in a machine washer and a machine dryer, the waterproof casing is configured to protect the sound emitter and switch during the cycles by at least one of sufficiently absorbing impact forces generated during the cycles and physically shielding the sound emitter and switch from water and heat to which the sound emitting device is exposed during the cycles.

15. The article of claim 14, wherein the article is one of a garment, shoe, backpack, bag, towel, bib, and bedding.

16. The article of claim 14, wherein the sound emitter faces a chamber defined by the body and the switch faces away from the chamber.

17. The article of claim 14, wherein the article is configured to be worn by a user such that the sound emitter faces or contacts the user during use and the switch projects in an opposite direction away from the user.

18. The article of claim 14, further comprising a support disposed between the sound emitter and switch, the support supporting a control unit in communication with both the sound emitter and switch and configured to control the sound emitter, the sound emitter is mounted on a first side of the support and faces away from the switch and control unit both of which are mounted on a second side of the support opposite the first side.

19. The article of claim 14, wherein the sound emitting device is configured such that triggering the switch a first time generates the sound, and triggering the switch a second time generates a different sound also related to or associated with the article.

20. The article of claim 14, further including a pushbutton used to trigger the switch, the sound emitting device configured such that depression of the pushbutton for a predetermined period of time turns the sound emitting device off, wherein when the sound emitting device is off depression of the pushbutton does not generate the sound.
